(19) United States
(12) Patent Application Publication
(10) Pub. No.: US 2002/0095302 A1
(43) Pub. Date: Jul. 18, 2002

(54) Apparatus and method for managing ideas

(75) Inventor: Shohei Moriwaki, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/887,324

(22) Filed: Jun. 25, 2001

(30) Foreign Application Priority Data
Jan. 18, 2001 (JP) 2001-009676

(51) Int. Cl. G06F 17/60

(52) U.S. Cl. 705/1

(57) ABSTRACT

An idea provider makes a NDA at a contracting unit after connecting a provider terminal to an idea managing apparatus and stores the idea in an idea file. On the other hand, an idea user makes an NDA at the contracting unit after connecting a user terminal to the idea managing apparatus and searches for an idea to be implemented in the idea file at a searching unit. The search result is output onto a display at the user terminal. Thus, the idea managing apparatus can advertise for a company which desires to implement the self-created idea not protected by right while maintaining the novelty of the idea.

### BACKGROUND OF THE INVENTION

1. Field of the Invention

The present invention relates to idea managing apparatuses and, more specifically, to an idea managing apparatus which can be connected between a provider terminal of an idea provider and a user terminal of an idea user over a network.

2. Description of the Background Art

Conventionally, ideas such as inventions can be created not only by employees of large companies but also by those of small and medium-sized companies and even by individuals.

However, if a created idea belongs to an employee of a small and medium-sized company or an individual who does not have sufficient fund, the idea would never be implemented and, rather, kept in dead storage or discarded because of the shortage of capital to implement the idea despite potential contribution to the industrial development of the idea.

On the other hand, for large companies with huge capitals, despite their sufficient capital investment capabilities, the employees of the company cannot create ideas which deserve investment in plant and equipment.

In this case, the individual or the employee of the small and medium-sized company would acquire the right in a self-created idea in the form of a patent or the like, and then advertise for a company which desires to acquire and implement the idea for value.

However, some individuals who have created such ideas may wish to advertise for a company which desires to implement the idea while still protecting novelty of the idea before acquiring the right in the idea, as the acquisition cost is high.

### SUMMARY OF THE INVENTION

An object of the present invention is to provide an idea managing apparatus capable of advertising for a company which desires to implement an idea created by an individual or an employee of a small and medium-sized company with insufficient capital and not yet protected by right while maintaining the novelty of the idea.

The idea managing apparatus of the present invention refers to an idea managing apparatus that can be connected between a provider terminal possessed by an idea provider providing an idea and a user terminal possessed by an idea user using the idea over a network. The idea managing apparatus includes: a storing unit storing in an idea file an idea transmitted from the provider terminal of the idea provider; and a contracting unit creating an on-line Non Disclosure Agreement (hereinafter abbreviated as NDA) between the idea provider and idea user for the stored idea and creating an on-line licensing agreement between the idea user and idea provider when the idea user wishes to implement the stored idea.

Thus, the idea provider can advertise for an idea user such as a company who wishes to implement the idea while maintaining the novelty of the idea without having to acquire the right in the self-created idea.

Preferably, the above mentioned idea managing apparatus includes a searching unit capable of searching for a stored idea either by a keyword or according to categories.

Thus, the idea user can readily select an idea to be implemented from ideas stored in the idea managing apparatus.

More preferably, the above mentioned storing unit stores information on the idea provider and user, i.e., agreeing parties of the NDA, as well as the content of the licensing agreement. The above mentioned contracting unit prohibits access to the idea for which the licensing agreement has been established by idea users other than the agreeing party of the licensing agreement.

Thus, the information on the idea provider and user that have made the NDA and, if the licensing agreement has been made, the content thereof can be stored and managed. Since access to the idea for which the licensing agreement has been established is prohibited, possible infringement of right in the idea by a third party can be prevented from occurring.

An idea managing method of the present invention refers to an idea managing method using an idea managing apparatus which can be connected between a provider terminal possessed by an idea provider providing an idea and a user terminal possessed by an idea user using the idea over a network. The method includes steps of: storing the idea transmitted from the provider terminal of the idea provider; and creating an on-line NDA between the idea provider and user for the stored idea and creating an on-line licensing agreement between the idea user and provider when the idea user wishes to implement the stored idea.

Thus, the idea provider can advertise for an idea user such as a company who wishes to implement the idea while maintaining the novelty of the idea without having to acquire the right in the self-created idea.

Preferably, the idea managing method further includes a step of searching for the stored idea either by a keyword or according to categories.

Thus, the idea user can readily select an idea to be implemented from those stored in the idea managing apparatus.

More preferably, the storing step further includes a step of storing information on the idea provider and user who have made the NDA as well as the content of the licensing agreement if the licensing agreement has been established. The above mentioned contracting step includes a step of prohibiting access to the idea for which the licensing agreement has been established by idea users other than the agreeing party of the licensing agreement.

Thus, the information on the idea provider and user who have made the NDA and, if the licensing agreement has been established, the content thereof can be stored and managed. Further, since access to the idea for which the licensing agreement has been established is prohibited, possible infringement of right in the idea by a third party can be prevented from occurring.

According to the present invention, the idea provider can advertise for a user of a self-created idea which has not been protected by right while maintaining the novelty of the idea.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall structure of an idea managing system according to an embodiment of the present invention.

FIG. 2 is a flow chart showing an operation of the idea managing system shown in FIG. 1, up to registration of an idea created by an idea provider in an idea managing apparatus 10.

FIG. 3 is a flow chart showing an operation of accessing the idea stored in idea managing apparatus 10 by the idea user in the idea managing system shown in FIG. 1.

FIG. 4 is a diagram showing search results output onto a display of user terminal 2 in a step S38 of FIG. 3.

FIG. 5 is a flow chart showing an operation of making a licensing agreement with an idea provider by an idea user in the idea managing system shown in FIG. 1.

### DESCRIPTION OF THE PREFERRED EMBODIMENTS

Now, embodiments of the present invention will be described in detail with reference to the drawings. It is noted that the same or corresponding portions are denoted by the same reference numerals throughout the drawings and description thereof will not be repeated.

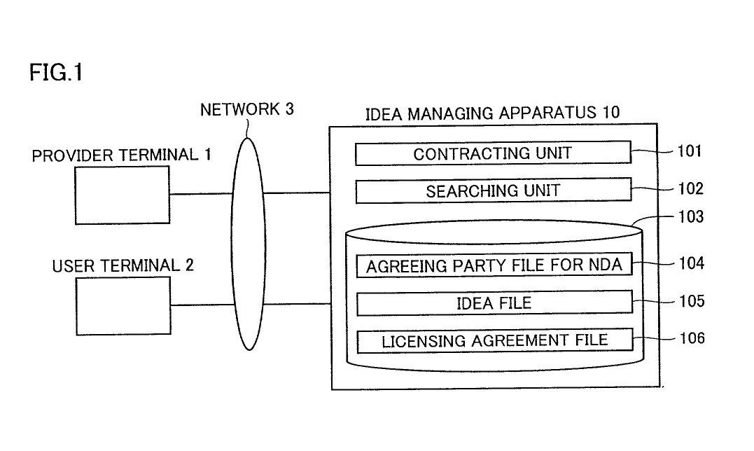

FIG. 1 is a block diagram showing an overall structure of an idea managing system according to an embodiment of the present invention.

Referring to FIG. 1, an idea managing apparatus 10 possessed by an idea managing company is connected between a provider terminal 1 of an idea provider and a user terminal 2 of an idea user over a network 3.

Idea managing apparatus 10 includes a contracting unit 101, a searching unit 102, and a hard disk 103.

Hard disk 103 includes an agreeing party file for NDA 104 storing information on agreeing parties of an NDA established between an idea provider and user, an idea file 105 storing an idea transmitted from the idea provider, and a licensing agreement file storing a content of a licensing agreement if it is established between the idea provider and user.

Contracting unit 101 allows the idea provider and user to make an NDA. Contracting unit 101 also allows the idea user and provider to make an on-line licensing agreement.

Searching unit 102 searches for an idea that the idea user wishes to access from idea file 105 by a keyword input by the idea user or according to categories.

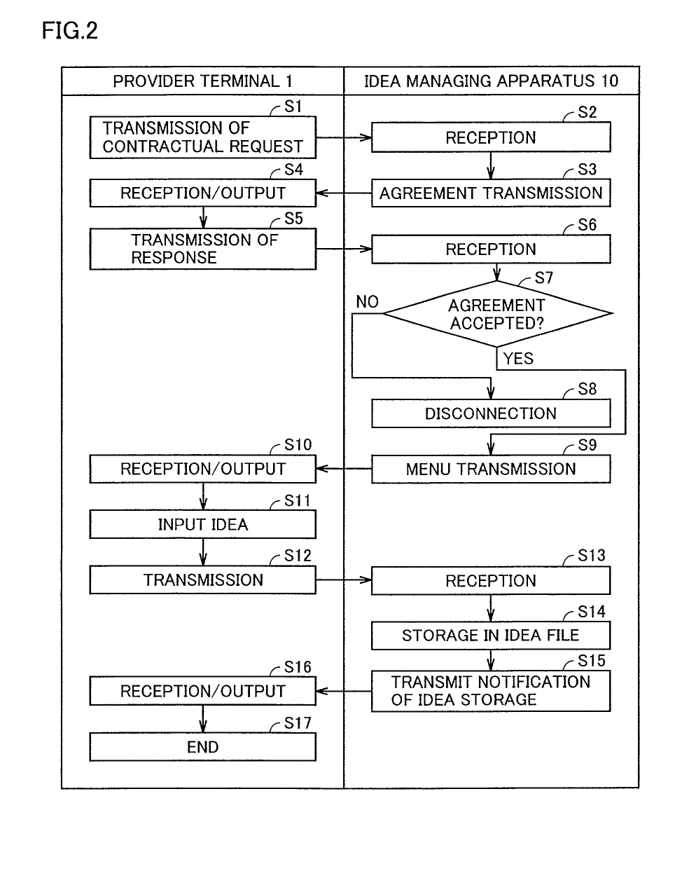

FIG. 2 is a flow chart showing an operation of the idea managing system shown in FIG. 1, up to registration of the idea created by the idea provider in idea managing apparatus 10 of the idea managing company.

Referring to FIG. 2, when the idea provider registers the self-created idea which is not protected by right in idea managing apparatus 10, an contractual request is transmitted from provider terminal 1 to initially make an NDA (a step S1). The contractual request transmitted from provider terminal 1 is received by idea managing apparatus 10 over network 3 (a step S2). Idea managing apparatus 10 that has received the contractual request transmits an NDA registration menu from contracting unit 101 (a step S3). The NDA registration menu provides notices in utilizing the idea managing system and, in particular, states that duty to confidentiality is imposed for the idea to be provided for the purpose of maintaining the novelty of the subject idea. After receiving the NDA registration menu transmitted from idea managing apparatus 10, provider terminal 1 outputs it onto a display (not shown) (a step S4).

After confirming the content of the NDA registration menu output to provider terminal 1, the idea provider inputs a response to the NDA to provider terminal 1 with use of a keyboard or a mouse (not shown) for transmission to idea managing apparatus 10 (a step S5).

After receiving the response to the NDA transmitted from provider terminal 1 (a step S6), idea managing apparatus 10 confirms the response to the NDA at contracting unit 101 (a step S7). If the idea provider rejects the NDA, idea managing apparatus 10 is disconnected from provider terminal 1 of the idea provider (a step S8). If the idea provider accepts the NDA, idea managing apparatus 10 transmits an idea input screen menu to provider terminal 1 of the idea provider (a step S9).

After receiving the idea input screen menu transmitted from the idea managing apparatus, provider terminal 1 of the idea provider outputs it onto a display at provider terminal 1 (a step S10).

The idea input screen menu includes a title of the idea, applicable field of the idea, and a summary of the idea such as an object or abstract. The menu may also include a detailed description of the idea and, if necessary, a drawing. The menu also includes information on the idea provider such as name or address made available to identify the idea provider. The idea provider makes input with use of a keyboard or a mouse for the self-created idea on the menu screen output on the display at provider terminal 1 (a step S11).

The idea provider inputs the self-created idea and then transmits the content of the idea to idea managing apparatus 10 (a step S12).

After receiving the idea input by the idea provider transmitted from provider terminal 1 (a step S13), idea managing apparatus 10 stores the content of the idea in idea file 105 in hard disk 105 of idea managing apparatus 10 (a step S14). At this point, the idea provider of the idea stored in idea file 105 becomes an agreeing party of the NDA. After idea managing apparatus 10 stores the idea in idea file 105, it notifies to provider terminal 1 of completion of the idea storage (a step S15).

After receiving the notification of completion of idea storage that has been transmitted from idea managing apparatus 10, provider terminal 1 outputs it onto the display at provider terminal 1 (a step S16). After confirming the notification of completion of idea storage output on the display at provider terminal 1, the idea provider disconnects provider terminal 1 from the idea managing apparatus (a step S17).

The above described operation enables the idea provider to make an on-line NDA and to store the self-created idea in idea managing apparatus 10.

It is noted that the idea provider can register the idea in idea managing apparatus 10 free of charge.

Then, access to the idea stored in idea managing apparatus 10 by the idea user will be described.

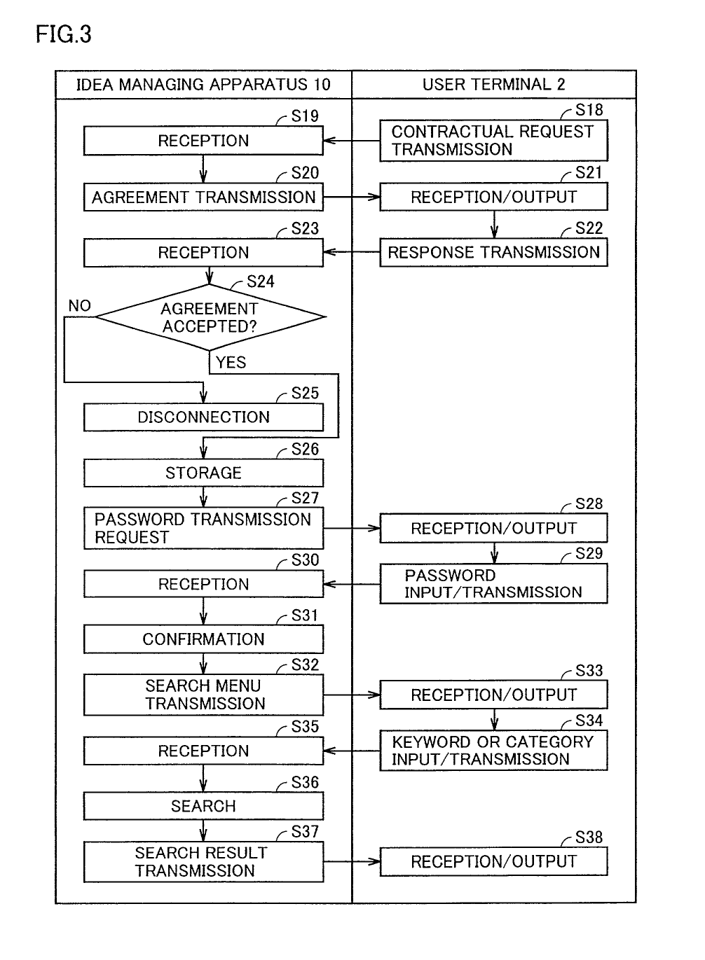

FIG. 3 is a flow chart showing an operation of making an access by the idea user to the ideas stored in idea managing apparatus 10 of the idea managing company.

Referring to FIG. 3, after connecting user terminal 2 to idea managing apparatus 10 over network 3, the idea user transmits a request for making an access to the idea stored in idea managing apparatus 10 (a step S18). The access request from user terminal 2 is received by idea managing apparatus 10 (a step S19).

Here, if an access to the idea that is not protected by right is allowed to a third party, duty to confidentiality must be imposed on the third party for the purpose of maintaining the novelty of the idea. Thus, idea managing apparatus 10 transmits an NDA registration menu to user terminal 2 of the idea user (a step S20). After receiving the NDA registration menu transmitted from idea managing apparatus 10, user terminal 2 outputs the content of the NDA registration menu onto a display (not shown) at user terminal 2 (a step S21). After reviewing the content of the NDA, the idea user transmits a determination as to if he or she accepts the NDA to idea managing apparatus 10 (a step S22). It is noted that, if the idea user accepts the NDA, he or she transmits such an acceptance along with a self-determined password.

After receiving the response transmitted from user terminal 2 (a step S23), idea managing apparatus 10 determines if the idea user has accepted the NDA at contracting unit 101 (a step S24). If contracting unit 101 determines that the idea user has rejected the NDA, idea managing apparatus 10 is disconnected from user terminal 2 (a step S25). On the other hand, if contracting unit 101 determines that the idea user has accepted the contract, idea managing apparatus 10 determines the idea user as an agreeing party of the NDA and stores in agreeing party file for NDA 104 of hard disk 103 information identifying the idea user such as a name of the idea user and a password determined by the idea user, included in the response from user terminal 2 (a step S26).

Successively, idea managing apparatus 10 transmits a request for password transmission to user terminal 2 to make a reconfirmation of the password of the idea user stored in agreeing party file for NDA 104 (a step S27). After receiving the request for password transmission from idea managing apparatus 10, user terminal 2 outputs it onto the display (a step S28). By the request for password transmission output onto the display at user terminal 2, the idea user again inputs the password, that has been transmitted to idea managing apparatus 10 along with the acceptance of the NDA in S22, for transmission (a step S29).

After receiving the password transmitted from user terminal 2 (a step S30), idea managing apparatus 10 determines at contracting unit 101 if the password received in step S30 match that stored in agreeing party file for NDA 104 in step S26 (a step S31). If the confirmation result indicates matching of the passwords, idea managing apparatus 10 transmits an idea searching menu used for searching for a stored idea to user terminal 2 (a step S32).

After receiving the idea searching menu transmitted from idea managing apparatus 10, user terminal 2 outputs the menu onto the display at user terminal 2 (a step S33).

The idea searching menu provides two kinds of searching methods, i.e., category search where search is made in accordance with a category of an idea to be accessed, and keyword search where search is made by a keyword of the idea to be accessed.

In accordance with the search menu screen output onto the display at user terminal 2, the idea user inputs a keyword or category of the idea to be accessed with use of a keyboard or a mouse to user terminal 2 for transmission to idea managing apparatus 10 (a step S34).

After receiving the keyword or category transmitted from user terminal 2 (a step S35), idea managing apparatus 10 searches for an idea to which the idea user wishes to access from idea file 105 at searching unit 102 in accordance with the keyword or category transmitted from user terminal 2 (a step S36), and transmits the search result to user terminal 2 (a step S37). The search result from idea managing apparatus 10 is received by user terminal 2 and output onto the display at user terminal 2 (a step S38).

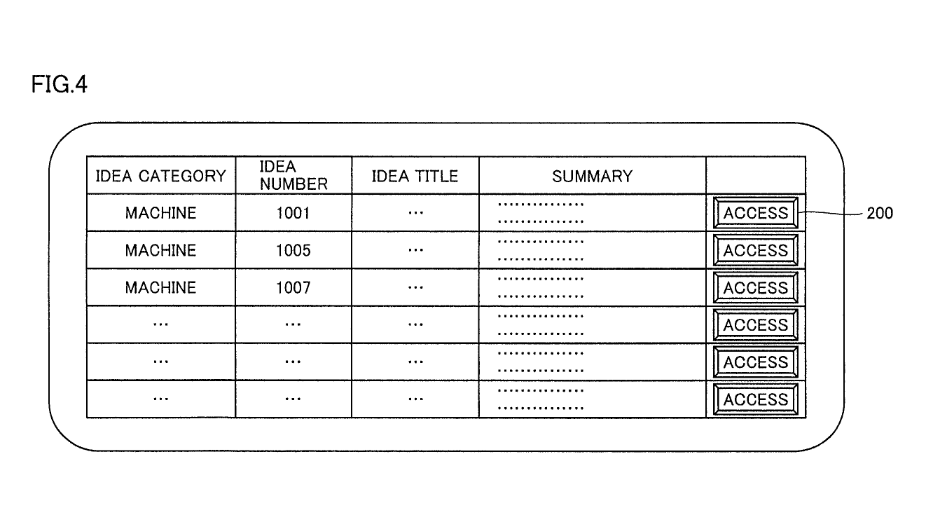

The search result output on the display at user terminal 2 in step S38 is displayed as shown in FIG. 4.

Referring to FIG. 4, the search result output onto the display at user terminal 2 has a search result table comprised of columns of an idea category, idea number, idea title, and a summary. “Idea category” states the applicable field of the idea. “Idea number” successively denotes the ideas registered in idea managing apparatus 10. “Idea title” states titles of the ideas which has been self-created by the idea providers. “Summary” contains an abstract of the idea, including the content and purpose of the idea.

At the right end of the row of each idea in the search result table, there is an “access” icon 200 as shown in the drawing. Looking at the title or summary of the idea, the idea user clicks icon 200 if he or she wishes to make an access to the detailed description thereof. If the idea user clicks icon 200, the content of the idea, e.g., detailed description thereof and drawing of the idea of icon 200, is output onto the display at user terminal 2.

By the above described operation, if the idea user accepts the NDA, he or she can make an access to the idea stored in idea managing apparatus 10 that is provided by the idea provider.

Then, acceptance to a licensing agreement by the idea user with the idea provider when the idea user finds an idea that he or she desires to implement as a result of accessing the idea stored in idea managing apparatus 10 will be described.

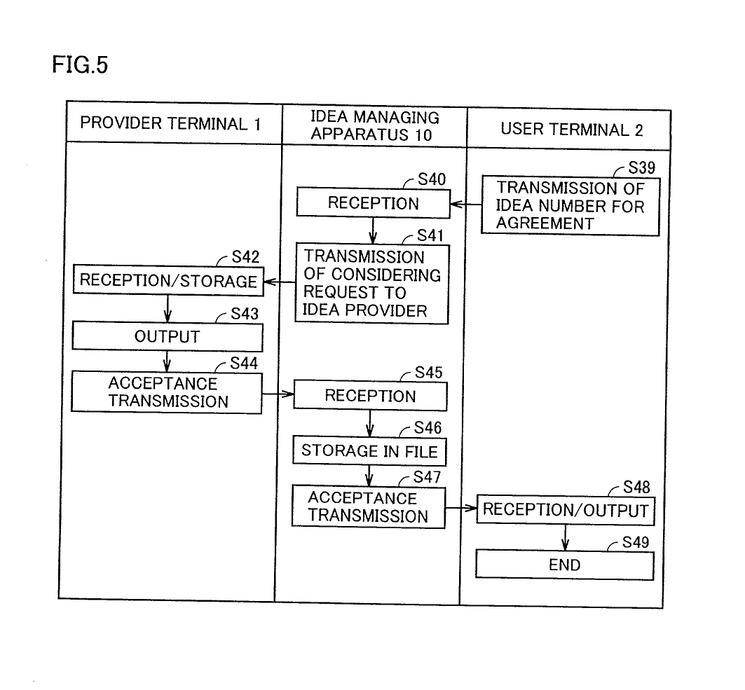

FIG. 5 is a flow chart showing an operation of accepting the licensing agreement by the idea user with the idea provider in the idea managing system shown in FIG. 1.

Referring to FIG. 5, the idea user inputs an idea number of the idea that he or she desires to implement at user terminal 2 for transmission to idea managing apparatus 10 over network 3 (a step S39).

Idea managing apparatus 10 that has received the idea number of the idea to be implemented from user terminal 2 (a step S40) transmits a request for considering to accept the licensing agreement to provider terminal 1 of the idea provider who has created the idea of that idea number (a step S41).

The content of the licensing agreement transmitted from idea managing apparatus 10 to provider terminal 1 of the idea provider includes a name and address of the idea user who desires to accept the licensing agreement and, if the idea user is a company, a capital capability or the like of that company.

After receiving the licensing agreement transmitted from idea managing apparatus 10, provider terminal 1 temporarily stores it in a hard disk (not shown) at provider terminal 1 until an access is made by the idea provider (a step S42). The idea provider outputs the licensing agreement stored in provider terminal 1 onto the display at provider terminal 1 (a step S43), and confirms the content.

If the idea provider accepts the licensing agreement, the acceptance is input to provider terminal 1 for transmission to idea managing apparatus 10 (a step S44).

After receiving the acceptance from provider terminal 1 (a step S45), idea managing apparatus 10 determines the idea for which the licensing agreement has been established at contracting unit 101, and prohibits access by a third party to the information on that idea in idea file 105, and stores the content of the licensing agreement in licensing agreement file 106 (a step S46).

The content of the licensing agreement includes information for identifying the idea provider and user that have made the licensing agreement in addition to the content of the idea for the licensing agreement.

After storing the content of the licensing agreement in licensing agreement file 106, idea managing apparatus 10 transmits to user terminal 2 of the idea user a notification that the licensing agreement has been established (a step S47).

After receiving the notification that the licensing agreement has been established from idea managing apparatus 10, user terminal 2 at the idea user outputs it onto the display at user terminal 2.

It is noted that the content of the licensing agreement transmitted in step S41 may also include specific contents of the licensing agreement (value, the term of the licensing agreement and so on), which can be determined on-line through idea managing apparatus 10 (a step S48). The idea user ends the usage of user terminal 2.

If the licensing agreement is made between the idea provider and user, the idea managing company that possesses idea managing apparatus 10 charges a commission on the idea provider and user.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An idea managing apparatus connectable between a provider terminal of an idea provider providing an idea and a user terminal of an idea user using the idea over a network, comprising:
a storing unit storing an idea transmitted from the provider terminal of said idea provider; and
a contracting unit allowing said idea user and idea provider to make an on-line Non Disclosure Agreement for said stored idea and allowing said idea user and idea provider to make an on-line licensing agreement when said idea user wishes to implement said stored idea.

2. The idea managing apparatus according to claim 1, further comprising a searching unit capable of searching for said stored idea by a keyword or according to a category.

3. The idea managing apparatus according to claim 1, wherein said storing unit further stores information on said idea provider and said idea user that have made said Non Disclosure Agreement and a content of said licensing agreement, and
said contracting unit prohibits access by a third party idea user other than said idea user of an agreeing party of said licensing agreement to the idea for which said licensing agreement has been established.

4. An idea managing method using an idea managing apparatus connectable between a provider terminal of an idea provider providing an idea and a user terminal of an idea user using the idea over a network, comprising the steps of:
storing an idea transmitted from the provider terminal of said idea provider; and
making an on-line Non Disclosure Agreement between said idea provider and said idea user for said stored idea and making an on-line licensing agreement between said idea user and said idea provider when said idea user wishes to implement said stored idea.

5. The idea managing method according to claim 4, further comprising the step of searching for said stored idea by a keyword or according to categories.

6. The idea managing method according to claim 4, wherein said storing step further includes the step of storing information on said idea provider and said idea user that have made said Non Disclosure Agreement as well as a content of said licensing agreement, and
said contracting step includes the step of prohibiting access by a third party idea user other than said idea user of an agreeing party of said licensing agreement to the idea for which said licensing agreement has been established.
